(19) United States
(12) Patent Application Publication
(10) Pub. No.: US 2026/0121514 A1
(43) Pub. Date: Apr. 30, 2026

(54) ELECTRIC POWER CONVERSION APPARATUS AND ELECTRIC POWER CONVERSION SYSTEM

(71) Applicant: TDK Corporation, Tokyo (JP)

(72) Inventor: Kazuki MATSUBARA, Tokyo (JP)

(73) Assignee: TDK Corporation, Tokyo (JP)

(21) Appl. No.: 19/006,496

(22) Filed: Dec. 31, 2024

(30) Foreign Application Priority Data
Jan. 11, 2024 (JP) 2024-002584
Jun. 26, 2024 (JP) 2024-102950

(51) Int. Cl. H02M 1/14; H02M 1/088; H02M 3/335

(52) U.S. Cl. CPC H02M 1/143; H02M 1/088; H02M 3/33569

(57) ABSTRACT

An electric power conversion apparatus includes: first and second electric power terminals; a switching circuit; a transformer; a rectifying circuit; a smoothing circuit including a first inductor and a first capacitor; an electric power regeneration circuit; and a control circuit. The electric power regeneration circuit includes: a first diode including an anode coupled to the rectifying circuit, and a cathode coupled to a first node; a second capacitor having one end coupled to the first node and another end coupled to a reference node; a first regeneration switching device having one end coupled to the first node and another end coupled to a second node; a second regeneration switching device having one end coupled to the second node and another end coupled to the reference node; and a second inductor and a second diode provided on a path coupling the second node and the one end of the first capacitor.

### CROSS-REFERENCE TO RELATED APPLICATIONS

The present application claims priority from Japanese Patent Application No. 2024-002584 filed on Jan. 11, 2024 and Japanese Patent Application No. 2024-102950 filed on Jun. 26, 2024, the entire contents of each of which are hereby incorporated by reference.

### BACKGROUND

The disclosure relates to an electric power conversion apparatus and an electric power conversion system that each convert electric power.

Some of electric power conversion apparatuses are adapted to suppress degradation and/or damaging of a switching device included therein. For example, Japanese Unexamined Patent Application Publication (JP-A) No. 2018-061381 discloses an electric power conversion apparatus that allows for suppression of degradation and/or damaging of circuitry arising from an avalanche breakdown.

### SUMMARY

An electric power conversion apparatus according to one embodiment of the disclosure includes a first electric power terminal, a switching circuit, a transformer, a rectifying circuit, a smoothing circuit, an electric power regeneration circuit, a control circuit, and a second electric power terminal. The switching circuit is coupled to the first electric power terminal. The transformer includes a first winding and a second winding. The first winding is led to the switching circuit. The rectifying circuit is coupled to the second winding and includes one or more rectification switching devices. The smoothing circuit includes a first inductor and a first capacitor. The first inductor has a first end and a second end. The first capacitor has a first end coupled to the second end of the first inductor, and a second end coupled to a reference node. The electric power regeneration circuit is coupled to the rectifying circuit and is configured to allow electric power to be regenerated in the first capacitor. The control circuit is configured to control an operation of each of the switching circuit, the rectifying circuit, and the electric power regeneration circuit. The second electric power terminal includes a first coupling terminal and a second coupling terminal. The first coupling terminal is coupled to the second end of the first inductor and the first end of the first capacitor. The second coupling terminal is coupled to the reference node. The electric power regeneration circuit includes a first diode, a second capacitor, a first regeneration switching device, a second regeneration switching device, a second inductor, and a second diode. The first diode includes an anode coupled to the rectifying circuit, and a cathode coupled to a first node. The second capacitor has a first end coupled to the first node, and a second end coupled to the reference node. The first regeneration switching device has a first end coupled to the first node, and a second end coupled to a second node. The second regeneration switching device has a first end coupled to the second node, and a second end coupled to the reference node. The second inductor and the second diode are provided on a path coupling the second node and the first end of the first capacitor to each other. The control circuit is configured to control an operation of each of the first regeneration switching device and the second regeneration switching device, based on a voltage at the second capacitor.

An electric power conversion system according to one embodiment of the disclosure includes a first battery, a capacitor, a first switch, a second switch, an electric power conversion apparatus, and a second battery. The first battery includes a first terminal and a second terminal. The capacitor includes a first terminal and a second terminal. The first switch is provided on a path coupling the first terminal of the first battery and the first terminal of the capacitor to each other. The second switch is provided on a path coupling the second terminal of the first battery and the second terminal of the capacitor to each other. The electric power conversion apparatus includes a first electric power terminal, a switching circuit, a transformer, a rectifying circuit, a smoothing circuit, an electric power regeneration circuit, a control circuit, and a second electric power terminal. The first electric power terminal is coupled to the capacitor. The switching circuit is coupled to the first electric power terminal. The transformer includes a first winding and a second winding. The first winding is led to the switching circuit. The rectifying circuit is coupled to the second winding and includes one or more rectification switching devices. The smoothing circuit includes a first inductor and a first capacitor. The first inductor has a first end and a second end. The first capacitor has a first end coupled to the second end of the first inductor, and a second end coupled to a reference node. The electric power regeneration circuit is coupled to the rectifying circuit and is configured to allow electric power to be regenerated in the first capacitor. The control circuit is configured to control an operation of each of the switching circuit, the rectifying circuit, and the electric power regeneration circuit. The second electric power terminal is coupled to the second battery and includes a first coupling terminal and a second coupling terminal. The first coupling terminal is coupled to the second end of the first inductor and the first end of the first capacitor. The second coupling terminal is coupled to the reference node. The electric power regeneration circuit includes a first diode, a second capacitor, a first regeneration switching device, a second regeneration switching device, a second inductor, and a second diode. The first diode includes an anode coupled to the rectifying circuit, and a cathode coupled to a first node. The second capacitor has a first end coupled to the first node, and a second end coupled to the reference node. The first regeneration switching device has a first end coupled to the first node, and a second end coupled to a second node. The second regeneration switching device has a first end coupled to the second node, and a second end coupled to the reference node. The second inductor and the second diode are provided on a path coupling the second node and the first end of the first capacitor to each other. The control circuit is configured to control an operation of each of the first regeneration switching device and the second regeneration switching device, based on a voltage at the second capacitor.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a configuration example of an electric power conversion system according to one example embodiment of the disclosure.

FIG. 2 is a circuit diagram illustrating a configuration example of an electric power regeneration circuit illustrated in FIG. 1.

FIG. 3 is a timing waveform diagram illustrating an example of an electric power conversion operation of the electric power conversion system illustrated in FIG. 1.

FIG. 4 is an explanatory diagram illustrating an operation example of a control circuit illustrated in FIG. 1.

FIG. 5 is a timing waveform diagram illustrating an example of a precharge operation of the electric power conversion system illustrated in FIG. 1.

FIG. 6A is an explanatory diagram illustrating an operation state of the electric power regeneration circuit illustrated in FIG. 2 in a precharge period.

FIG. 6B is an explanatory diagram illustrating another operation state of the electric power regeneration circuit illustrated in FIG. 2 in the precharge period.

FIG. 6C is an explanatory diagram illustrating still another operation state of the electric power regeneration circuit illustrated in FIG. 2 in the precharge period.

FIG. 6D is an explanatory diagram illustrating yet another operation state of the electric power regeneration circuit illustrated in FIG. 2 in the precharge period.

FIG. 6E is an explanatory diagram illustrating a further operation state of the electric power regeneration circuit illustrated in FIG. 2 in the precharge period.

FIG. 6F is an explanatory diagram illustrating a still further operation state of the electric power regeneration circuit illustrated in FIG. 2 in the precharge period.

FIG. 6G is an explanatory diagram illustrating a yet further operation state of the electric power regeneration circuit illustrated in FIG. 2 in the precharge period.

FIG. 7 is a circuit diagram illustrating a configuration example of an electric power conversion system according to a modification example.

FIG. 8 is a circuit diagram illustrating a configuration example of an electric power regeneration circuit illustrated in FIG. 7.

FIG. 9 is a circuit diagram illustrating a configuration example of an electric power conversion system according to a modification example.

FIG. 10 is a circuit diagram illustrating a configuration example of an electric power regeneration circuit illustrated in FIG. 9.

### DETAILED DESCRIPTION

What is desired of an electric power conversion apparatus is to avoid an avalanche breakdown. The electric power conversion apparatus is thus expected to effectively avoid the avalanche breakdown.

It is desirable to provide an electric power conversion apparatus and an electric power conversion system that each make it possible to effectively avoid an avalanche breakdown.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.

### EXAMPLE EMBODIMENT

### Configuration Example

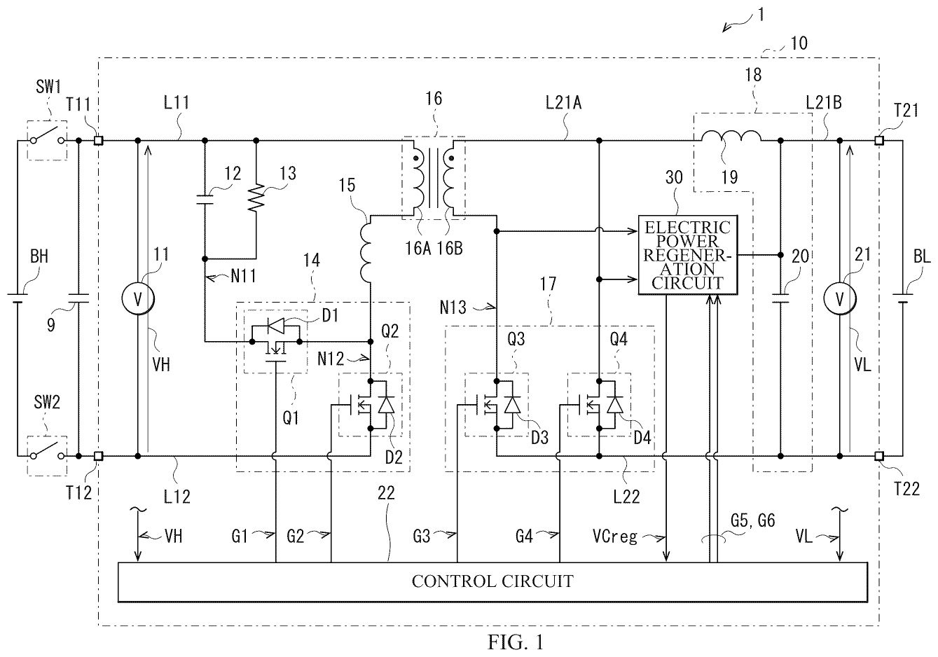

FIG. 1 illustrates a configuration example of an electric power conversion system 1 including an electric power conversion apparatus according to an example embodiment of the disclosure. The electric power conversion system 1 may include a high voltage battery BH, switches SW1 and SW2, a capacitor 9, an electric power conversion apparatus 10, and a low voltage battery BL. The electric power conversion system 1 may be configured to convert electric power supplied from the high voltage battery BH and to supply the converted electric power to the low voltage battery BL.

The high voltage battery BH may be configured to store electric power. The high voltage battery BH may supply the electric power to the electric power conversion apparatus 10 via the switches SW1 and SW2.

The switches SW1 and SW2 may be configured to, when turned on, allow the electric power stored in the high voltage battery BH to be supplied to the electric power conversion apparatus 10. The switches SW1 and SW2 may each include a relay, for example. When turned on, the switch SW1 may couple a positive terminal of the high voltage battery BH and a terminal T11 of the electric power conversion apparatus 10 to each other. When turned on, the switch SW2 may couple a negative terminal of the high voltage battery BH and a terminal T12 of the electric power conversion apparatus 10 to each other. The switches SW1 and SW2 may each be turned on or off in accordance with an instruction from an unillustrated system control processor.

The capacitor 9 may have a first end coupled to the terminal T11 of the electric power conversion apparatus 10 and to the switch SW1, and a second end coupled to the terminal T12 of the electric power conversion apparatus 10 and to the switch SW2.

The electric power conversion apparatus 10 may be configured to convert electric power by stepping down a voltage supplied from the high voltage battery BH, and to supply the converted electric power to the low voltage battery BL. The electric power conversion apparatus 10 may include the terminals T11 and T12, a voltage sensor 11, a capacitor 12, a resistor 13, a switching circuit 14, an inductor 15, a transformer 16, a rectifying circuit 17, a smoothing circuit 18, an electric power regeneration circuit 30, a voltage sensor 21, a control circuit 22, and terminals T21 and T22. Primary-side circuitry of the electric power conversion system 1 may include the high voltage battery BH, the switches SW1 and SW2, the voltage sensor 11, the capacitor 12, the resistor 13, the switching circuit 14, and the inductor 15. Secondary-side circuitry of the electric power conversion system 1 may include the rectifying circuit 17, the smoothing circuit 18, the electric power regeneration circuit 30, the voltage sensor 21, and the low voltage battery BL.

The terminals T11 and T12 may be configured to receive the voltage from the high voltage battery BH when the switches SW1 and SW2 are turned on. In the electric power conversion apparatus 10, the terminal T11 may be coupled to a voltage line L11, and the terminal T12 may be coupled to a reference voltage line L12.

The voltage sensor 11 may have a first end coupled to the voltage line L11, and a second end coupled to the reference voltage line L12. The voltage sensor 11 may be configured to detect a voltage VH at the voltage line L11 with respect to a voltage at the reference voltage line L12.

The capacitor 12 may have a first end coupled to the voltage line L11, and a second end coupled to a node N11. The resistor 13 may have a first end coupled to the voltage line L11, and a second end coupled to the node N11.

The switching circuit 14 may be configured to perform a switching operation, based on control signals G1 and G2. The switching circuit 14 may include transistors Q1 and Q2. The transistors Q1 and Q2 may be switching devices that perform switching operations, respectively based on the control signals G1 and G2. The transistors Q1 and Q2 may each include an N-type field-effect transistor (FET), for example. The transistors Q1 and Q2 may respectively include body diodes D1 and D2. For example, the body diode D1 may have an anode coupled to a source of a body of the transistor Q1, and a cathode coupled to a drain of the body of the transistor Q1. This may similarly apply to the body diode D2. Note that although the N-type field-effect transistor may be used in this example embodiment, this is non-limiting, and any kind of switching device may be used. The transistor Q1 may have the drain coupled to the node N11, the source coupled to a node N12, and a gate to receive the control signal G1. The transistor Q2 may have a drain coupled to the node N12, a source coupled to the reference voltage line L12, and a gate to receive the control signal G2.

The inductor 15 may have a first end coupled to a winding 16A of the transformer 16, and a second end coupled to the node N12. The winding 16A will be described later.

The transformer 16 may be configured to provide direct-current isolation and alternating-current coupling between the primary-side circuitry and the secondary-side circuitry, and to convert an alternating-current voltage supplied from the primary-side circuitry with a transformation ratio N of the transformer 16 to thereby supply the converted alternating-current voltage to the secondary-side circuitry. The transformer 16 may include the winding 16A and a winding 16B. The winding 16A may be a primary winding of the transformer 16. The winding 16A may have a first end coupled to the voltage line L11, and a second end coupled to the first end of the inductor 15. The winding 16B may be a secondary winding of the transformer 16. The winding 16B may have a first end coupled to a voltage line L21A, and a second end coupled to a node N13. The voltage line L21A will be described later.

The rectifying circuit 17 may be configured to rectify the alternating-current voltage outputted from the winding 16B of the transformer 16. The rectifying circuit 17 may include transistors Q3 and Q4. The transistors Q3 and Q4 may be switching devices that perform switching operations, respectively based on control signals G3 and G4. The transistors Q3 and Q4 may each include, for example, an N-type field-effect transistor, as with the transistors Q1 and Q2. The transistors Q3 and Q4 may respectively include body diodes D3 and D4, similarly to the transistors Q1 and Q2. The transistor Q3 may have a drain coupled to the node N13, a source coupled to a reference voltage line L22, and a gate to receive the control signal G3. The transistor Q4 may have a drain coupled to the voltage line L21A, a source coupled to the reference voltage line L22, and a gate to receive the control signal G4.

The smoothing circuit 18 may be configured to smooth the voltage rectified by the rectifying circuit 17. The smoothing circuit 18 may include an inductor 19 and a capacitor 20. The inductor 19 may have a first end coupled to the voltage line L21A, and a second end coupled to a voltage line L21B. The capacitor 20 may have a first end coupled to the voltage line L21B, and a second end coupled to the reference voltage line L22.

The electric power regeneration circuit 30 may be configured to allow electric power of a surge that occurs in each of the transistors Q3 and Q4 of the rectifying circuit 17 to be regenerated in the capacitor 20.

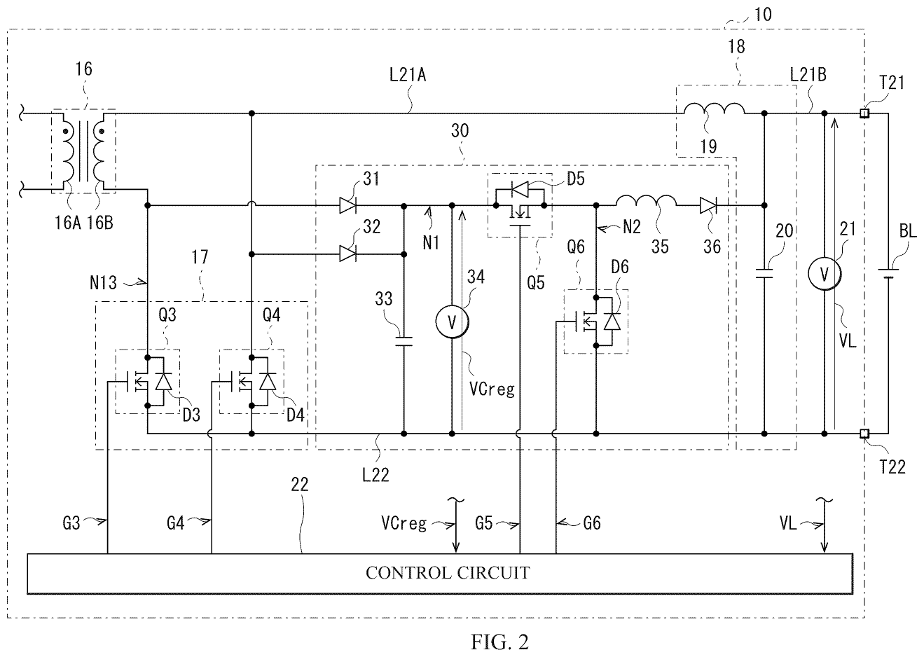

FIG. 2 illustrates a configuration example of the electric power regeneration circuit 30. In FIG. 2, the secondary-side circuitry of the electric power conversion system 1 is illustrated that includes the electric power regeneration circuit 30. The electric power regeneration circuit 30 may include diodes 31 and 32, a capacitor 33, a voltage sensor 34, transistors Q5 and Q6, an inductor 35, and a diode 36.

The diode 31 may have an anode coupled to the node N13, and a cathode coupled to a node N1. The diode 32 may have an anode coupled to the voltage line L21A, and a cathode coupled to the node N1. The capacitor 33 may have a first end coupled to the node N1, and a second end coupled to the reference voltage line L22. The voltage sensor 34 may have a first end coupled to the node N1, and a second end coupled to the reference voltage line L22. The voltage sensor 34 may be configured to detect a voltage VCreg at the node N1 with respect to a voltage at the reference voltage line L22.

The transistors Q5 and Q6 may be switching devices that perform switching operations, respectively based on control signals G5 and G6. The transistors Q5 and Q6 may each include, for example, an N-type field-effect transistor, as with the transistors Q1 to Q4. The transistors Q5 and Q6 may respectively include body diodes D5 and D6, similarly to the transistors Q1 to Q4. The transistor Q5 may have a drain coupled to the node N1, a source coupled to a node N2, and a gate to receive the control signal G5. The transistor Q6 may have a drain coupled to the node N2, a source coupled to the reference voltage line L22, and a gate to receive the control signal G6.

The inductor 35 may have a first end coupled to the node N2, and a second end coupled to an anode of the diode 36. The diode 36 may have the anode coupled to the second end of the inductor 35, and a cathode coupled to the first end of the capacitor 20.

This configuration makes it possible for the electric power regeneration circuit 30 to allow electric power of a surge that occurs in each of the transistors Q3 and Q4 of the rectifying circuit 17 to be regenerated in the capacitor 20.

The voltage sensor 21 illustrated in FIG. 1 may have a first end coupled to the voltage line L21B, and a second end coupled to the reference voltage line L22. The voltage sensor 21 may be configured to detect a voltage VL at the voltage line L21B with respect to the voltage at the reference voltage line L22.

The control circuit 22 may be configured to control an operation of the electric power conversion apparatus 10, based on the voltage VH detected by the voltage sensor 11, the voltage VL detected by the voltage sensor 21, and the voltage VCreg detected by the voltage sensor 34 of the electric power regeneration circuit 30. The control circuit 22 may include a microcontroller, for example.

The terminals T21 and T22 may be configured to supply electric power generated by the electric power conversion apparatus 10 to the low voltage battery BL. In the electric power conversion apparatus 10, the terminal T21 may be coupled to the voltage line L21B, and the terminal T22 may be coupled to the reference voltage line L22. Further, the terminal T21 may be coupled to a positive terminal of the low voltage battery BL, and the terminal T22 may be coupled to a negative terminal of the low voltage battery BL.

The low voltage battery BL may be configured to store the electric power supplied from the electric power conversion apparatus 10.

With this configuration, the electric power conversion system 1 may perform an electric power conversion operation of converting electric power supplied from the high voltage battery BH and supplying the converted electric power to the low voltage battery BL.

Further, the electric power conversion system 1 may also have a capability of performing what is called a precharge operation, that is, an operation of charging the capacitor 9 in a period before starting the electric power conversion operation described above. In the precharge operation, the switches SW1 and SW2 may be off, and the control circuit 22 may control the operation of each of the switching circuit 14, the rectifying circuit 17, and the electric power regeneration circuit 30 to thereby allow the electric power conversion system 1 to supply electric power of the low voltage battery BL to the capacitor 9 via the transformer 16. This helps to reduce, in the electric power conversion apparatus 10, an inrush current flowing from the high voltage battery BH to the capacitor 9 when the switches SW1 and SW2 are turned on to perform the electric power conversion operation.

Here, the terminals T11 and T12 may correspond to a specific but non-limiting example of a “first electric power terminal” in one embodiment of the disclosure. The switching circuit 14 may correspond to a specific but non-limiting example of a “switching circuit” in one embodiment of the disclosure. The transformer 16 may correspond to a specific but non-limiting example of a “transformer” in one embodiment of the disclosure. The winding 16A may correspond to a specific but non-limiting example of a “first winding” in one embodiment of the disclosure. The winding 16B may correspond to a specific but non-limiting example of a “second winding” in one embodiment of the disclosure. The rectifying circuit 17 may correspond to a specific but non-limiting example of a “rectifying circuit” in one embodiment of the disclosure. The smoothing circuit 18 may correspond to a specific but non-limiting example of a “smoothing circuit” in one embodiment of the disclosure. The inductor 19 may correspond to a specific but non-limiting example of a “first inductor” in one embodiment of the disclosure. The capacitor 20 may correspond to a specific but non-limiting example of a “first capacitor” in one embodiment of the disclosure. The reference voltage line L22 may correspond to a specific but non-limiting example of a “reference node” in one embodiment of the disclosure. The electric power regeneration circuit 30 may correspond to a specific but non-limiting example of an “electric power regeneration circuit” in one embodiment of the disclosure. The terminals T21 and T22 may correspond to a specific but non-limiting example of a “second electric power terminal” in one embodiment of the disclosure. The control circuit 22 may correspond to a specific but non-limiting example of a “control circuit” in one embodiment of the disclosure.

The diode 31 may correspond to a specific but non-limiting example of a “first diode” in one embodiment of the disclosure. The capacitor 33 may correspond to a specific but non-limiting example of a “second capacitor” in one embodiment of the disclosure. The transistor Q5 may correspond to a specific but non-limiting example of a “first regeneration switching device” in one embodiment of the disclosure. The transistor Q6 may correspond to a specific but non-limiting example of a “second regeneration switching device” in one embodiment of the disclosure. The inductor 35 may correspond to a specific but non-limiting example of a “second inductor” in one embodiment of the disclosure. The diode 36 may correspond to a specific but non-limiting example of a “second diode” in one embodiment of the disclosure. The node N1 may correspond to a specific but non-limiting example of a “first node” in one embodiment of the disclosure. The node N2 may correspond to a specific but non-limiting example of a “second node” in one embodiment of the disclosure. The transistor Q3 may correspond to a specific but non-limiting example of a “first rectification switching device” in one embodiment of the disclosure. The transistor Q4 may correspond to a specific but non-limiting example of a “second rectification switching device” in one embodiment of the disclosure. The diode 32 may correspond to a specific but non-limiting example of a “third diode” in one embodiment of the disclosure.

### [Operation and Workings]

Next, a description will be given of an operation and workings of the electric power conversion system 1 of the example embodiment.

### [Outline of Overall Operation]

First, an outline of an overall operation of the electric power conversion system 1 will be described with reference to FIG. 1. When the electric power conversion system 1 starts up, the switches SW1 and SW2 may be off. First, the control circuit 22 may generate the control signals G1 to G6 in a precharge period. The electric power conversion apparatus 10 may perform switching operations, based on the control signals G1 to G6, and may supply electric power of the low voltage battery BL from the secondary-side circuitry to the primary-side circuitry via the transformer 16 to thereby charge the capacitor 9. This may cause the voltage VH to rise and be kept at or near a target voltage. Thereafter, in an electric power conversion period after the precharge period, the switches SW1 and SW2 may be turned on, and the control circuit 22 may generate the control signals G1 to G6. The electric power conversion apparatus 10 may perform the switching operations, based on the control signals G1 to G6, to convert electric power supplied from the high voltage battery BH and supply the converted electric power to the low voltage battery BL.

### [Detailed Operation]

An operation example of the electric power conversion system 1 will be described in detail below. The electric power conversion operation will be described first, and thereafter the precharge operation will be described.

### [Electric Power Conversion Operation]

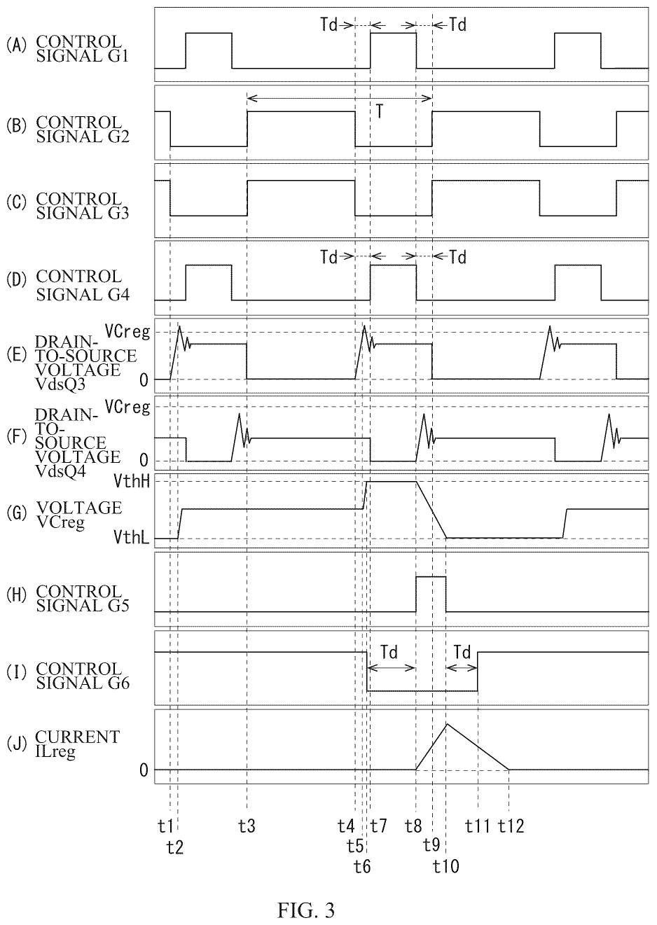

FIG. 3 illustrates an example operation to be performed by the electric power conversion system 1 in the electric power conversion period. Parts (A) to (D) of FIG. 3 respectively illustrate waveforms of the control signals G1 to G4. Part (E) of FIG. 3 illustrates a waveform of a drain-to-source voltage VdsQ3 of the transistor Q3. Part (F) of FIG. 3 illustrates a waveform of a drain-to-source voltage VdsQ4 of the transistor Q4. Part (G) of FIG. 3 illustrates a waveform of the voltage VCreg at the capacitor 33 of the electric power regeneration circuit 30. Parts (H) and (I) of FIG. 3 respectively illustrate waveforms of the control signals G5 and G6. Part (J) of FIG. 3 illustrates a waveform of a current ILreg flowing through the inductor 35 of the electric power regeneration circuit 30. In parts (A) to (D), (H), and (I) of FIG. 3, the control signals G1 to G6 are respectively represented based on gate-to-source voltages Vgs of the transistors Q1 to Q6. Note that the waveform of the voltage VCreg is also illustrated in parts (E) and (F) of FIG. 3. The waveform of the voltage VCreg may actually be as illustrated in part (G) of FIG. 3; however, due to differences in voltage scale, the waveform of the voltage VCreg in parts (E) and (F) of FIG. 3 is illustrated as being substantially constant.

When performing the electric power conversion operation, the control circuit 22 may generate the control signals G1 to G4, as illustrated in parts (A) to (D) of FIG. 3, based on the voltage VL. The control signals G1 and G2 may be so controlled that either the control signal G1 or the control signal G2 is at a high level. In performing the control, a dead time Td may be provided for the control signals G1 and G2. During the dead time Td, both the control signals G1 and G2 may be at a low level. Similarly, the control signals G3 and G4 may be so controlled that either the control signal G3 or the control signal G4 is at a high level. In performing the control, the dead time Td may be provided for the control signals G3 and G4. In this example, the control circuit 22 may change the control signal G2 from the high level to the low level at a timing t4, change the control signal G1 from the low level to the high level at a timing t7, change the control signal G1 from the high level to the low level at a timing t8, and change the control signal G2 from the low level to the high level at a timing t9, as illustrated in parts (A) and (B) of FIG. 3. Similarly, the control circuit 22 may change the control signal G3 from the high level to the low level at the timing t4, change the control signal G4 from the low level to the high level at the timing t7, change the control signal G4 from the high level to the low level at the timing t8, and change the control signal G3 from the low level to the high level at the timing t9, as illustrated in parts (C) and (D) of FIG. 3. The control circuit 22 may repeat such an operation with a switching period T. The electric power conversion apparatus 10 may perform the switching operations, based on the above-described control signals G1 to G4 to thereby perform the electric power conversion operation of converting electric power supplied from the high voltage battery BH and supplying the converted electric power to the low voltage battery BL. In addition, the electric power conversion apparatus 10 may so control respective duty ratios of the control signals G1 to G4 as to cause the voltage VL to remain at a predetermined voltage.

In the electric power conversion operation described above, the electric power regeneration circuit 30 may operate to allow electric power of a surge that occurs in the transistor Q3 to be regenerated. The electric power of the surge that occurs in the transistor Q3 may be supplied to the capacitor 33 of the electric power regeneration circuit 30 via the diode 31, and may be temporarily stored in the capacitor 33. The control circuit 22 may generate the control signals G5 and G6, based on the voltage VCreg at the capacitor 33. The electric power regeneration circuit 30 may thus allow the electric power of the surge that occurs in the transistor Q3 to be regenerated.

For example, when the control circuit 22 changes the control signal G3 from the high level to the low level at a timing t1 in this example (part (C) of FIG. 3), a state of the transistor Q3 may change from on to off. This may cause the drain-to-source voltage VdsQ3 of the transistor Q3 to rise from 0 V, as illustrated in part (E) of FIG. 3. The drain-to-source voltage VdsQ3 may transiently exceed the voltage VCreg at a timing t2. In a period in which the drain-to-source voltage VdsQ3 exceeds the voltage VCreg, the diode 31 may be turned on, and a current may thus flow into the capacitor 33 via the diode 31. In this way, the capacitor 33 may be charged transiently, which may cause the voltage VCreg at the capacitor 33 to rise, as illustrated in part (G) of FIG. 3. The voltage VCreg having risen may be lower than a threshold voltage VthH. Thereafter, at a timing t3, the control circuit 22 may change the control signal G3 from the low level to the high level as illustrated in part (C) of FIG. 3, which may change the state of the transistor Q3 from off to on. As a result, the drain-to-source voltage VdsQ3 of the transistor Q3 may drop to 0 V, as illustrated in part (E) of FIG. 3.

Similarly, when the control circuit 22 changes the control signal G3 from the high level to the low level at the timing t4 (part (C) of FIG. 3), the state of the transistor Q3 may change from on to off. This may cause the drain-to-source voltage VdsQ3 of the transistor Q3 to rise from 0 V, as illustrated in part (E) of FIG. 3. At a timing t5, the drain-to-source voltage VdsQ3 may transiently become high and the diode 31 may be turned on. The capacitor 33 may thus be charged transiently, which may cause the voltage VCreg at the capacitor 33 to rise, as illustrated in part (G) of FIG. 3. In this example, the voltage VCreg may reach the threshold voltage VthH at a timing t6. The control circuit 22 may generate the control signals G5 and G6, based on this voltage VCreg.

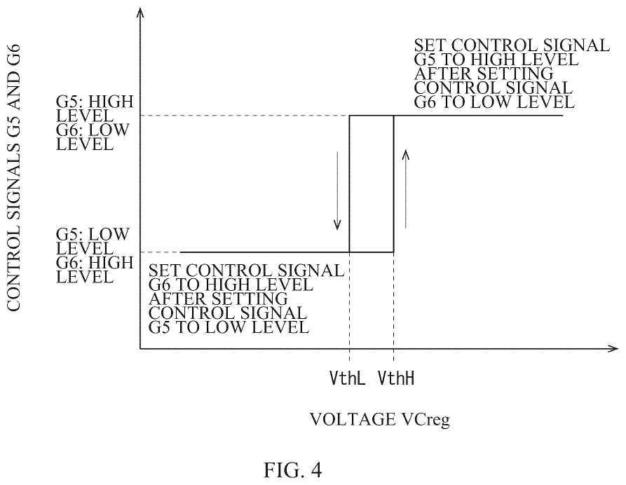

FIG. 4 illustrates an operation example of the control circuit 22. The control circuit 22 may generate the control signals G5 and G6 by comparing the voltage VCreg with a threshold voltage VthL and the threshold voltage VthH. The threshold voltage VthH may be higher than the threshold voltage VthL. Where the control signal G5 is at the low level and the control signal G6 is at the high level, the control circuit 22 may change the control signal G6 from the high level to the low level when the voltage VCreg rises and reaches the threshold voltage VthH, and thereafter, at a timing at which the dead time Td has elapsed from the timing of the change of the control signal G6 from the high level to the low level, the control circuit 22 may change the control signal G5 from the low level to the high level. Further, where the control signal G5 is at the high level and the control signal G6 is at the low level, the control circuit 22 may change the control signal G5 from the high level to the low level when the voltage VCreg drops and reaches the threshold voltage VthL, and thereafter, at a timing at which the dead time Td has elapsed from the timing of the change of the control signal G5 from the high level to the low level, the control circuit 22 may change the control signal G6 from the low level to the high level. In such a manner, the control circuit 22 may generate the control signals G5 and G6, based on the voltage VCreg and using a hysteresis characteristic.

As illustrated in FIG. 3, once the voltage VCreg reaches the threshold voltage VthH at the timing t6, the control circuit 22 may change the control signal G6 from the high level to the low level at this timing t6 (part (I) of FIG. 3). This may change a state of the transistor Q6 from on to off. Thereafter, at the timing t8 at which the dead time Td has elapsed from the timing t6, the control circuit 22 may change the control signal G5 from the low level to the high level. This may change a state of the transistor Q5 from off to on, and the current ILreg may thus flow from the capacitor 33 toward the capacitor 20 via the transistor Q5, the inductor 35, and the diode 36 (part (J) of FIG. 3). In other words, the electric power of the surge that occurs in the transistor Q3 may be temporarily stored in the capacitor 33 of the electric power regeneration circuit 30, and may be thereafter regenerated in the capacitor 20. The current ILreg may rise during a period from the timing t8 to a timing t10. Because the capacitor 33 is discharged, the voltage VCreg at the capacitor 33 may drop toward the threshold voltage VthL, as illustrated in part (G) of FIG. 3.

Once the voltage VCreg reaches the threshold voltage VthL at the timing t10, the control circuit 22 may change the control signal G5 from the high level to the low level at this timing t10, as illustrated in part (H) of FIG. 3. This may change the state of the transistor Q5 from on to off. Because the discharging of the capacitor 33 is thereby stopped, the voltage VCreg may remain at substantially the same voltage as the threshold voltage VthL, as illustrated in part (G) of FIG. 3. Thereafter, at a timing t11 at which the dead time Td has elapsed from the timing t10, the control circuit 22 may change the control signal G6 from the low level to the high level. This may change the state of the transistor Q6 from off to on. The current ILreg may drop during a period from the timing t10 to a timing t12.

In such a manner, the electric power regeneration circuit 30 may allow the electric power of the surge that occurs in the transistor Q3 to be regenerated.

Note that although the above-described example is where a surge occurs in the transistor Q3, the description above similarly applies to a case where a surge occurs in the transistor Q4.

### [Precharge Operation]

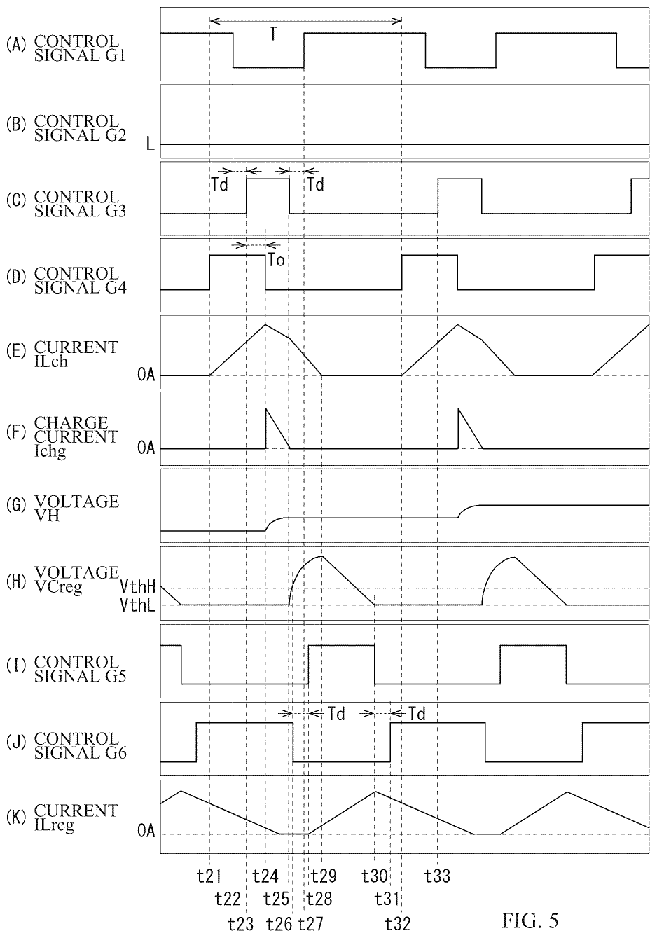

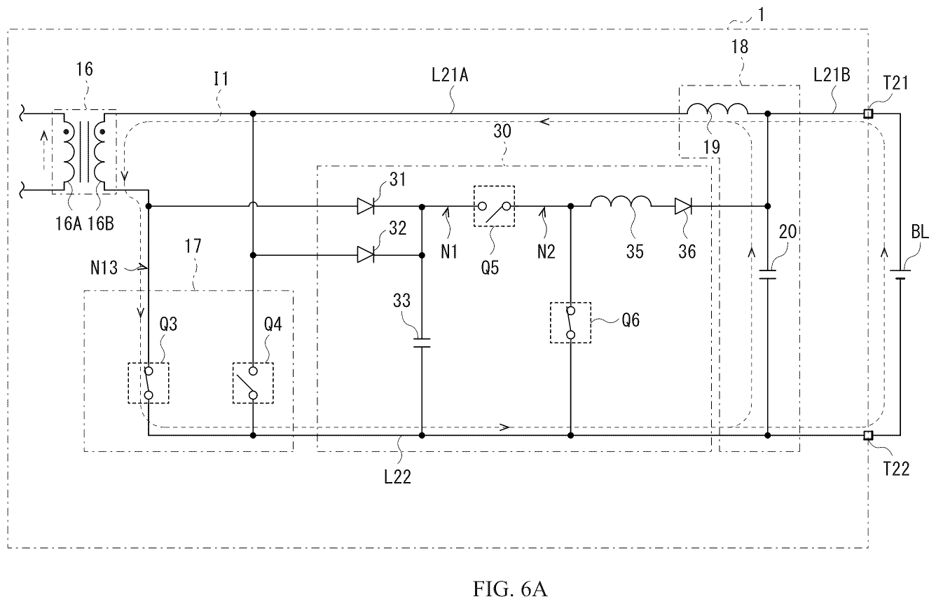

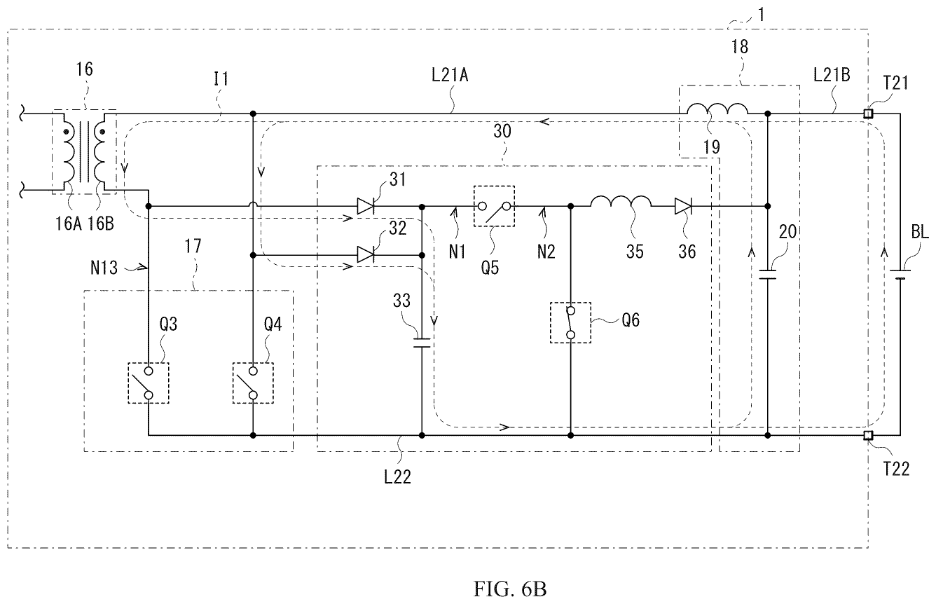

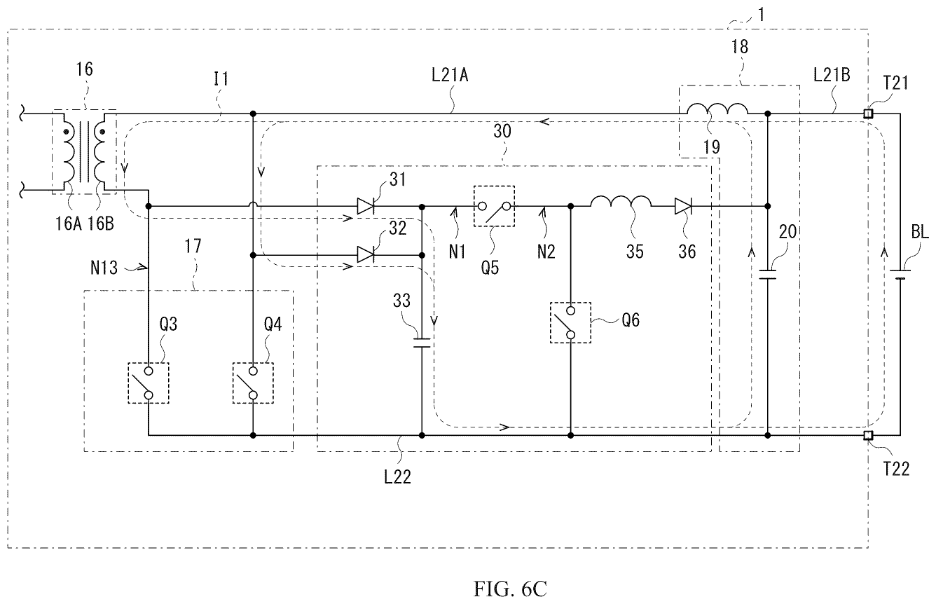

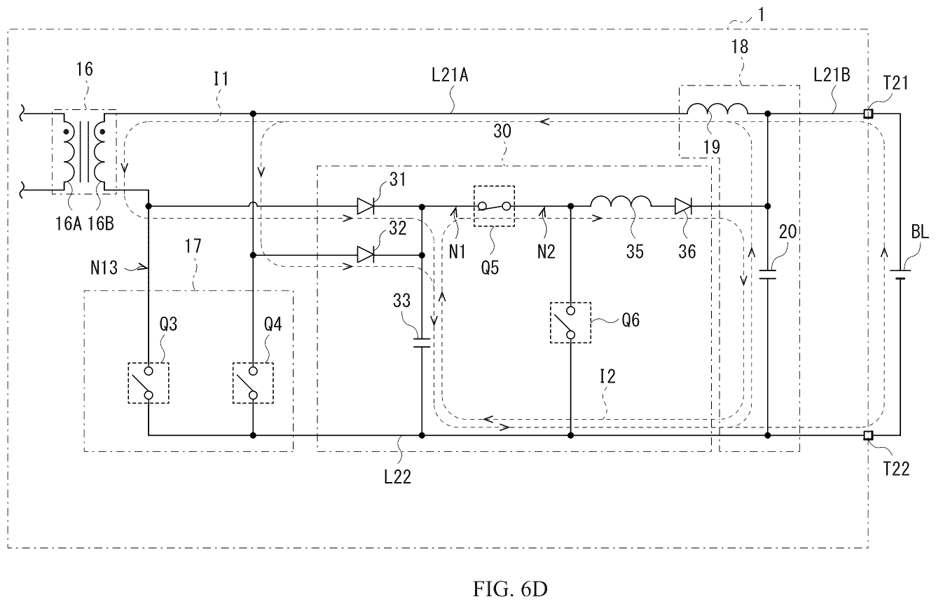

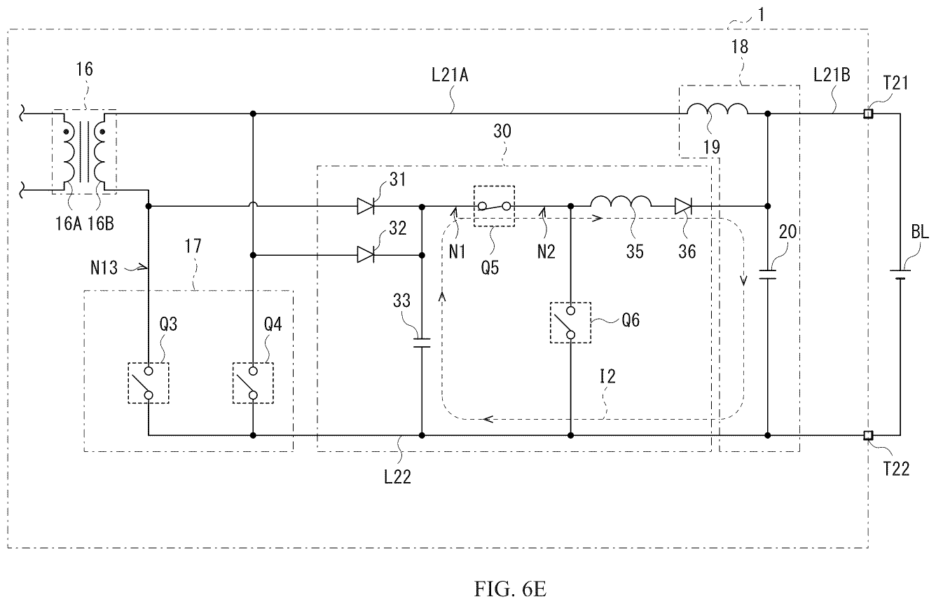

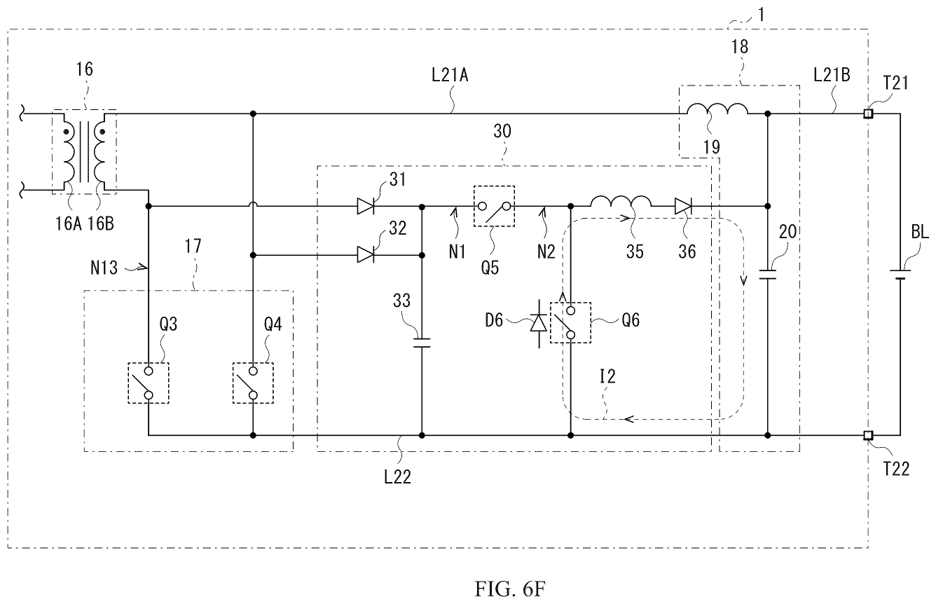

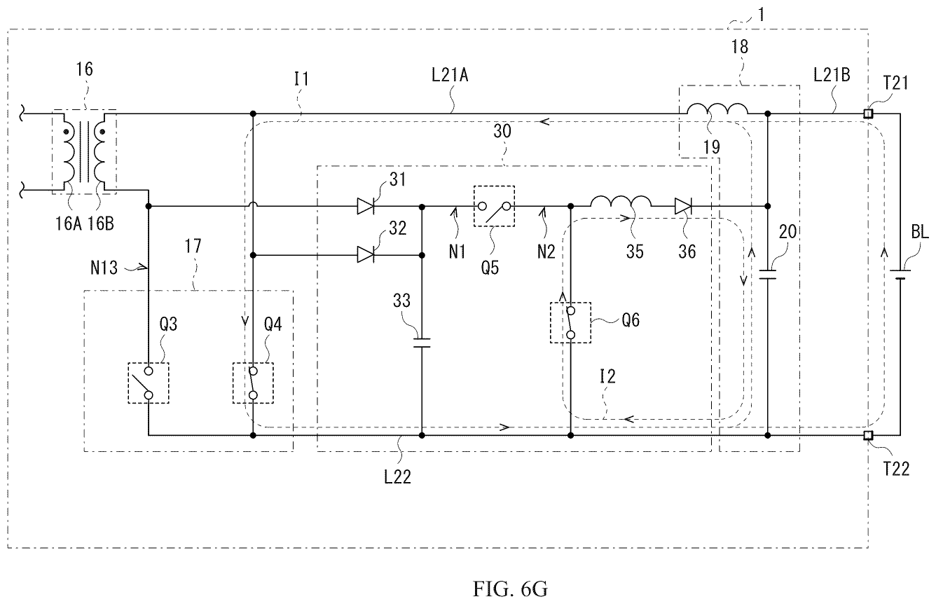

FIG. 5 illustrates an example operation to be performed by the electric power conversion system 1 in the precharge period. Parts (A) to (D) of FIG. 5 respectively illustrate the waveforms of the control signals G1 to G4. Part (E) of FIG. 5 illustrates a waveform of a current ILch flowing through the inductor 19 of the smoothing circuit 18. Part (F) of FIG. 5 illustrates a waveform of a charge current Ichg to the capacitor 9. Part (G) of FIG. 5 illustrates a waveform of the voltage VH. Part (H) of FIG. 5 illustrates the waveform of the voltage VCreg at the capacitor 33 of the electric power regeneration circuit 30. Parts (I) and (J) of FIG. 5 respectively illustrate the waveforms of the control signals G5 and G6. Part (K) of FIG. 5 illustrates the waveform of the current ILreg flowing through the inductor 35 of the electric power regeneration circuit 30. FIGS. 6A to 6G each illustrate an example operation state of the electric power conversion system 1. In FIGS. 6A to 6G, the transistors Q3 to Q6 are each represented by a symbol of a switch indicating the state of relevant one of the transistors. Further, in FIGS. 6A to 6G, the electric power regeneration circuit 30 is illustrated in a simplified manner.

When performing the precharge operation, the control circuit 22 may generate the control signals G1 to G4 (parts (A) to (D) of FIG. 5). The control signal G2 may be maintained at the low level, as illustrated in part (B) of FIG. 5. The control signals G1 and G3 may be so controlled that either the control signal G1 or the control signal G3 is at the high level. In performing the control, the dead time Td may be provided for the control signals G1 and G3. The control signals G3 and G4 may be so controlled that a period during which the control signal G3 is at the high level and a period during which the control signal G4 is at the high level overlap each other. A period during which both the control signals G3 and G4 are at the high level may be an overlap period To. In this example, the control circuit 22 may change the control signal G4 from the low level to the high level at a timing t21, as illustrated in part (D) of FIG. 5. The control circuit 22 may change the control signal G1 from the high level to the low level at a timing t22 and change the control signal G3 from the low level to the high level at a timing t23, as illustrated in parts (A) and (C) of FIG. 5. The control circuit 22 may change the control signal G4 from the high level to the low level at a timing t24, as illustrated in part (D) of FIG. 5. The control circuit 22 may change the control signal G3 from the high level to the low level at a timing t25 and change the control signal G1 from the low level to the high level at a timing t27, as illustrated in parts (A) and (C) of FIG. 5. The control circuit 22 may repeat such an operation with the switching period T. By performing the switching operations based on the control signals G1 to G4 described above, the electric power conversion apparatus 10 may supply electric power of the low voltage battery BL from the secondary-side circuitry to the primary-side circuitry via the transformer 16 to thereby charge the capacitor 9. For example, in periods during which the control signal G3 is at the high level, the electric power conversion apparatus 10 may convert electric power supplied from the low voltage battery BL and supply the converted electric power to the capacitor 9. This may cause the voltage VH at the capacitor 9 to gradually rise, as illustrated in part (G) of FIG. 5. The electric power conversion apparatus 10 may so control the respective duty ratios of the control signals G1, G3, and G4 as to cause the voltage VH to gradually rise toward a target voltage. The electric power conversion apparatus 10 may perform the precharge operation in such a manner.

In the precharge operation, the electric power regeneration circuit 30 may operate to allow electric power to be regenerated while avoiding an avalanche breakdown that can occur in each of the transistors Q3 and Q4. Electric power may be supplied to the capacitor 33 of the electric power regeneration circuit 30 via the diodes 31 and 32, and may be temporarily stored in the capacitor 33. The control circuit 22 may generate the control signals G5 and G6, based on the voltage VCreg at the capacitor 33. In such a manner, the electric power regeneration circuit 30 may allow the electric power to be regenerated.

For example, the control circuit 22 may change the control signal G3 from the low level to the high level at the timing t23 and change the control signal G4 from the high level to the low level at the timing t24, as illustrated in parts (C) and (D) of FIG. 5. This may cause the transistor Q3 to be on and cause the transistor Q4 to be off, as illustrated in FIG. 6A. In a period from the timing t24 to the timing t25, in the secondary-side circuitry, as illustrated in FIG. 6A, the electric power stored in the inductor 19 may be released, and a current I1 may thus flow through the inductor 19, the winding 16B of the transformer 16, the transistor Q3, the capacitor 20, and the low voltage battery BL in this order. The electric power may thus be supplied from the secondary-side circuitry to the primary-side circuitry via the transformer 16. In this period from the timing t24 to the timing t25, in the primary-side circuitry, the charge current Ichg may flow to the capacitor 9 (part (F) of FIG. 5), and the voltage VH may thus rise (part (G) of FIG. 5).

Thereafter, at the timing t25, the control circuit 22 may change the control signal G3 from the high level to the low level, as illustrated in part (C) of FIG. 5. This may cause the transistor Q3 to be off, as illustrated in FIG. 6B. In a period from the timing t25 to a timing t26, in the secondary-side circuitry, as illustrated in FIG. 6B, residual electric power stored in the inductor 19 may be released, and the current I1 may thus flow through the inductor 19, the winding 16B of the transformer 16, the diode 31, the capacitor 33, and the low voltage battery BL in this order, and through the inductor 19, the diode 32, the capacitor 33, and the low voltage battery BL in this order. Owing to the current I1, the capacitor 33 may be charged and the voltage VCreg may thus rise (part (H) of FIG. 5).

Once the voltage VCreg at the capacitor 33 reaches the threshold voltage VthH at the timing t26 (part (H) of FIG. 5) as a result of rising, the control circuit 22 may change the control signal G6 from the high level to the low level at this timing t26, as illustrated in part (J) of FIG. 5. This may cause the transistor Q6 to be off, as illustrated in FIG. 6C. In a period from the timing t26 to a timing t28, the voltage VCreg may continue to rise, as illustrated in part (H) of FIG. 5.

Thereafter, the control circuit 22 may change the control signal G5 from the low level to the high level at the timing t28 at which the dead time Td has elapsed from the timing t26, as illustrated in part (I) of FIG. 5. This may cause the transistor Q5 to be on, as illustrated in FIG. 6D. As a result, in a period from the timing t28 to a timing t29, a regenerative current I2 may flow through the capacitor 33, the transistor Q5, the inductor 35, the diode 36, and the capacitor 20 in this order, as illustrated in FIG. 6D. Thus, in the secondary-side circuity, the current I1 based on the electric power stored in the inductor 19 and the regenerative current I2 may flow. The current I1 may be a current to charge the capacitor 33, and the regenerative current I2 may be a current to discharge the capacitor 33. Owing to the regenerative current I2, the current ILreg flowing through the inductor 35 may start to increase at the timing t28, as illustrated in part (K) of FIG. 5.

When the electric power stored in the inductor 19 runs out at the timing t29, the current I1 may no longer flow, and the current ILch flowing through the inductor 19 may become zero, as illustrated in part (E) of FIG. 5. Accordingly, during a period from the timing t29 to a timing t30, the regenerative current I2 may keep flowing in the secondary-side circuitry, as illustrated in FIG. 6E. Because the regenerative current I2 is a current to discharge the capacitor 33, the voltage VCreg at the capacitor 33 may drop at and after the timing t29, as illustrated in part (H) of FIG. 5.

Once the voltage VCreg at the capacitor 33 reaches the threshold voltage VthL at the timing t30 (part (H) of FIG. 5) as a result of dropping, the control circuit 22 may change the control signal G5 from the high level to the low level at this timing t30, as illustrated in part (I) of FIG. 5. This may cause the transistor Q5 to be off, as illustrated in FIG. 6F. In a period from the timing t30 to a timing t31, the transistor Q6 may be of; however, the body diode D6 of the transistor Q6 may be turned on, which may allow the regenerative current I2 to flow through the inductor 35, the diode 36, the capacitor 20, and the body diode D6 of the transistor Q6 in this order, as illustrated in FIG. 6F. Because the transistor Q5 is turned off to allow no current to be supplied from the capacitor 33, the current ILreg (i.e., the regenerative current I2) flowing through the inductor 35 may start to decrease, as illustrated in part (K) of FIG. 5.

Thereafter, at the timing t31 at which the dead time Td has elapsed from the timing t30, the control circuit 22 may change the control signal G6 from the low level to the high level as illustrated in part (J) of FIG. 5, and may change the control signal G4 from the low level to the high level at a timing t32 as illustrated in part (D) of FIG. 5. This may cause the transistors Q4 and Q6 to be on, as illustrated in FIG. 6G. As a result, in a period from the timing t32 to a timing t33, the current I1 may flow through the inductor 19, the transistor Q4, the capacitor 20, and the low voltage battery BL in this order, as illustrated in FIG. 6G. Thus, in the secondary-side circuity, the regenerative current I2 and the current I1 may flow. Owing to the current I1, the current ILch flowing through the inductor 19 may start to increase at the timing t32 as illustrated in part (E) of FIG. 5, which may allow electric power to be stored in the inductor 19.

The electric power regeneration circuit 30 may repeat such an operation.

As illustrated in part (H) of FIG. 5, the voltage VCreg at the capacitor 33 may be about the same as each of the threshold voltages VthL and VthH, and may be, at the maximum, slightly higher than the threshold voltage VthH. A drain voltage of the transistor Q3 will not exceed a sum of the voltage VCreg and a forward voltage of the diode 31. Similarly, a drain voltage of the transistor Q4 will not exceed a sum of the voltage VCreg and a forward voltage of the diode 32. The electric power conversion system 1 thus helps to avoid an avalanche breakdown in each of the transistors Q3 and Q4.

As described above, the electric power conversion system 1 includes the first electric power terminal (the terminals T11 and T12), the switching circuit 14, the transformer 16, the rectifying circuit 17, the smoothing circuit 18, the electric power regeneration circuit 30, the control circuit 22, and the second electric power terminal (the terminals T21 and T22). The switching circuit 14 is coupled to the first electric power terminal (the terminals T11 and T12). The transformer 16 includes the first winding (the winding 16A) and the second winding (the winding 16B). The first winding (the winding 16A) is led to the switching circuit 14. The rectifying circuit 17 is coupled to the second winding (the winding 16B) and includes one or more rectification switching devices. The smoothing circuit 18 includes the first inductor (the inductor 19) and the first capacitor (the capacitor 20). The first inductor (the inductor 19) has the first end and the second end. The first capacitor (the capacitor 20) has the first end coupled to the second end of the first inductor (the inductor 19), and the second end coupled to the reference node (the reference voltage line L22). The electric power regeneration circuit 30 is coupled to the rectifying circuit 17 and is configured to allow electric power to be regenerated in the first capacitor (the capacitor 20). The control circuit 22 is configured to control an operation of each of the switching circuit 14, the rectifying circuit 17, and the electric power regeneration circuit 30. The second electric power terminal (the terminals T21 and T22) includes a first coupling terminal (the terminal T21) and a second coupling terminal (the terminal T22). The first coupling terminal (the terminal T21) is coupled to the second end of the first inductor (the inductor 19) and the first end of the first capacitor (the capacitor 20). The second coupling terminal (the terminal T22) is coupled to the reference node (the reference voltage line L22). The electric power regeneration circuit 30 includes the first diode (e.g., the diode 31), the second capacitor (the capacitor 33), the first regeneration switching device (the transistor Q5), the second regeneration switching device (the transistor Q6), the second inductor (the inductor 35), and the second diode (the diode 36). The first diode (e.g., the diode 31) includes the anode coupled to the rectifying circuit 17, and the cathode coupled to the first node (the node N1). The second capacitor (the capacitor 33) has the first end coupled to the first node (the node N1), and the second end coupled to the reference node (the reference voltage line L22). The first regeneration switching device (the transistor Q5) has a first end coupled to the first node (the node N1), and a second end coupled to the second node (the node N2). The second regeneration switching device (the transistor Q6) has a first end coupled to the second node (the node N2), and a second end coupled to the reference node (the reference voltage line L22). The second inductor (the inductor 35) and the second diode (the diode 36) are provided on a path coupling the second node (the node N2) and the first end of the first capacitor (the capacitor 20) to each other. The control circuit 22 is configured to control an operation of each of the first regeneration switching device (the transistor Q5) and the second regeneration switching device (the transistor Q6), based on the voltage at the second capacitor (the capacitor 33). This helps to make it possible for the electric power conversion system 1 to, in the precharge period, for example, allow electric power to be regenerated while avoiding an avalanche breakdown in each of the transistors Q3 and Q4, as illustrated in FIGS. 5 and 6A to 6G. Accordingly, the electric power conversion system 1 helps to allow for effective avoidance of the avalanche breakdown.

For example, a technique disclosed in JP-A No. 2018-061381 can involve a large current in allowing electric power to be regenerated. In such a case, it is necessary to use a large-sized component. The electric power conversion system 1 according to the example embodiment allows for a reduction in the current to flow through the electric power regeneration circuit 30, thus allowing for a circuit configuration with use of a small-sized component. Further, the electric power regeneration circuit 30 allows, in the precharge period, for example, electric power to be regenerated while avoiding an avalanche breakdown, and allows, in the electric power conversion period, for example, electric power of a surge that occurs in the transistor Q3 to be regenerated, as illustrated in FIG. 3. In this way, the electric power conversion system 1 allows for avoidance of the avalanche breakdown in the precharge operation and allows for regeneration of electric power of a surge in the electric power conversion operation, with the small-sized component used therein. As a result, the electric power conversion system 1 helps to effectively avoid the avalanche breakdown.

In some embodiments, in the electric power conversion system 1, the second winding (the winding 16B) may have a first end and a second end, the first end being coupled to the first end of the first inductor (the inductor 19). The one or more rectification switching devices may include the first rectification switching device (the transistor Q3) and the second rectification switching device (the transistor Q4). The first rectification switching device (the transistor Q3) may have a first end coupled to the second end of the second winding (the winding 16B), and a second end coupled to the reference node (the reference voltage line L22). The second rectification switching device (the transistor Q4) may have a first end coupled to the first end of the second winding (the winding 16B), and a second end coupled to the reference node (the reference voltage line L22). The anode of the first diode (the diode 31) may be coupled to the first end of the first rectification switching device (the transistor Q3). The electric power regeneration circuit 30 may further include the third diode (the diode 32). The third diode (the diode 32) may have the anode coupled to the first end of the second rectification switching device (the transistor Q4), and the cathode coupled to the first node (the node N1). With such a configuration, the electric power conversion system 1 helps to effectively avoid an avalanche breakdown in each of the transistors Q3 and Q4.

In some embodiments, in the electric power conversion system 1, the control circuit 22 may be configured to control the operation of each of the switching circuit 14 and the rectifying circuit 17 to cause electric power to be supplied from the second electric power terminal (the terminals T21 and T22) toward the first electric power terminal (the terminals T11 and T12) in a predetermined period (the precharge period) before a period (the electric power conversion period) in which electric power is to be supplied from the first electric power terminal (the terminals T11 and T12) toward the second electric power terminal (the terminals T21 and T22), and may be configured to change a state of the first rectification switching device (the transistor Q3) from on to off in the predetermined period (the precharge period). The electric power regeneration circuit 30 may be configured to, in a first period that is within the predetermined period (the precharge period) and after the state of the first rectification switching device (the transistor Q3) changes to off, charge the second capacitor (the capacitor 33) by causing a current to flow through the first inductor (the inductor 19), the second winding (the winding 16B), the first diode (the diode 31), and the second capacitor (the capacitor 33) in this order. This helps to allow the electric power conversion system 1 to store electric power in the capacitor 33 while avoiding an avalanche breakdown in the transistor Q3. As a result, the electric power conversion system 1 helps to effectively avoid the avalanche breakdown in the transistor Q3.

In some embodiments, in the electric power conversion system 1, the control circuit 22 may be configured to control the operation of each of the switching circuit 14 and the rectifying circuit 17 to cause electric power to be supplied from the second electric power terminal (the terminals T21 and T22) toward the first electric power terminal (the terminals T11 and T12) in a predetermined period (the precharge period) before a period (the electric power conversion period) in which electric power is to be supplied from the first electric power terminal (the terminals T11 and T12) toward the second electric power terminal (the terminals T21 and T22), and may be configured to, in the predetermined period (the precharge period), change a state of the first regeneration switching device (the transistor Q5) from off to on after the voltage at the second capacitor (the capacitor 33) reaches a predetermined threshold voltage (the threshold voltage VthH). The electric power regeneration circuit 30 may be configured to, in a second period that is within the predetermined period (the precharge period) and after the state of the first regeneration switching device (the transistor Q5) changes to on, charge the first capacitor (the capacitor 20) by causing a current to flow, from the second capacitor (the capacitor 33), through the first regeneration switching device (the transistor Q5), the second inductor (the inductor 35), the second diode (the diode 36), and the first capacitor (the capacitor 20) in this order. This helps to allow the electric power stored in the capacitor 33 to be regenerated in the capacitor 20 in the electric power conversion system 1. As a result, the electric power conversion system 1 helps to effectively avoid an avalanche breakdown.

In some embodiments, in the electric power conversion system 1, the control circuit 22 may be configured to control the operation of each of the switching circuit 14 and the rectifying circuit 17 to cause electric power to be supplied from the second electric power terminal (the terminals T21 and T22) toward the first electric power terminal (the terminals T11 and T12) in a predetermined period (the precharge period) before a period (the electric power conversion period) in which electric power is to be supplied from the first electric power terminal (the terminals T11 and T12) toward the second electric power terminal (the terminals T21 and T22), and may be configured to cause the first regeneration switching device (the transistor Q5) to be off and cause the second regeneration switching device (the transistor Q6) to be on in a third period within the predetermined period (the precharge period). The electric power regeneration circuit 30 may be configured to, in the third period, charge the first capacitor (the capacitor 20) by causing a current to flow through the second inductor (the inductor 35), the second diode (the diode 36), the first capacitor (the capacitor 20), and the second regeneration switching device (the transistor Q6) in this order. This helps to allow the electric power stored in the inductor 35 to be regenerated in the capacitor 20 in the electric power conversion system 1. As a result, the electric power conversion system 1 helps to effectively avoid an avalanche breakdown.

### Example Effects

As described above, an electric power conversion apparatus or an electric power conversion system according to at least one embodiment of the disclosure includes a first electric power terminal, a switching circuit, a transformer, a rectifying circuit, a smoothing circuit, an electric power regeneration circuit, a control circuit, and a second electric power terminal. The switching circuit is coupled to the first electric power terminal. The transformer includes a first winding and a second winding. The first winding is led to the switching circuit. The rectifying circuit is coupled to the second winding and includes one or more rectification switching devices. The smoothing circuit includes a first inductor and a first capacitor. The first inductor has a first end and a second end. The first capacitor has a first end coupled to the second end of the first inductor, and a second end coupled to a reference node. The electric power regeneration circuit is coupled to the rectifying circuit and is configured to allow electric power to be regenerated in the first capacitor. The control circuit is configured to control an operation of each of the switching circuit, the rectifying circuit, and the electric power regeneration circuit. The second electric power terminal includes a first coupling terminal and a second coupling terminal. The first coupling terminal is coupled to the second end of the first inductor and the first end of the first capacitor. The second coupling terminal is coupled to the reference node. The electric power regeneration circuit includes a first diode, a second capacitor, a first regeneration switching device, a second regeneration switching device, a second inductor, and a second diode. The first diode includes an anode coupled to the rectifying circuit, and a cathode coupled to a first node. The second capacitor has a first end coupled to the first node, and a second end coupled to the reference node. The first regeneration switching device has a first end coupled to the first node, and a second end coupled to a second node. The second regeneration switching device has a first end coupled to the second node, and a second end coupled to the reference node. The second inductor and the second diode are provided on a path coupling the second node and the first end of the first capacitor to each other. The control circuit is configured to control an operation of each of the first regeneration switching device and the second regeneration switching device, based on a voltage at the second capacitor. This helps to effectively avoid an avalanche breakdown.

In some embodiments, the second winding may have a first end and a second end, the first end being coupled to the first end of the first inductor. The one or more rectification switching devices may include a first rectification switching device and a second rectification switching device. The first rectification switching device may have a first end coupled to the second end of the second winding, and a second end coupled to the reference node. The second rectification switching device may have a first end coupled to the first end of the second winding, and a second end coupled to the reference node. The anode of the first diode may be coupled to the first end of the first rectification switching device. The electric power regeneration circuit may further include a third diode including an anode coupled to the first end of the second rectification switching device, and a cathode coupled to the first node. This helps to effectively avoid an avalanche breakdown.

In some embodiments, the control circuit may be configured to control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal, and may be configured to change a state of the first rectification switching device from on to off in the predetermined period. The electric power regeneration circuit may be configured to, in a first period that is within the predetermined period and after the state of the first rectification switching device changes to off, charge the second capacitor by causing a current to flow through the first inductor, the second winding, the first diode, and the second capacitor in this order. This helps to effectively avoid an avalanche breakdown.

In some embodiments, the control circuit may be configured to control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal, and may be configured to change, in the predetermined period, a state of the first regeneration switching device from off to on after the voltage at the second capacitor reaches a predetermined threshold voltage. The electric power regeneration circuit may be configured to, in a second period that is within the predetermined period and after the state of the first regeneration switching device changes to on, charge the first capacitor by causing a current to flow, from the second capacitor, through the first regeneration switching device, the second inductor, the second diode, and the first capacitor in this order. This helps to effectively avoid an avalanche breakdown.

In some embodiments, the control circuit may be configured to control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal, and may be configured to cause the first regeneration switching device to be off and cause the second regeneration switching device to be on in a third period within the predetermined period. The electric power regeneration circuit may be configured to, in the third period, charge the first capacitor by causing a current to flow through the second inductor, the second diode, the first capacitor, and the second regeneration switching device in this order. This helps to effectively avoid an avalanche breakdown.

### Modification Examples

In the foregoing example embodiment, the technique of one embodiment of the disclosure is applied to the electric power conversion system 1 having the circuit configuration illustrated in FIG. 1; however, this is non-limiting. The technique of one embodiment of the disclosure is applicable to any of electric power conversion systems having various circuit configurations. Some of such modification examples will be described below.

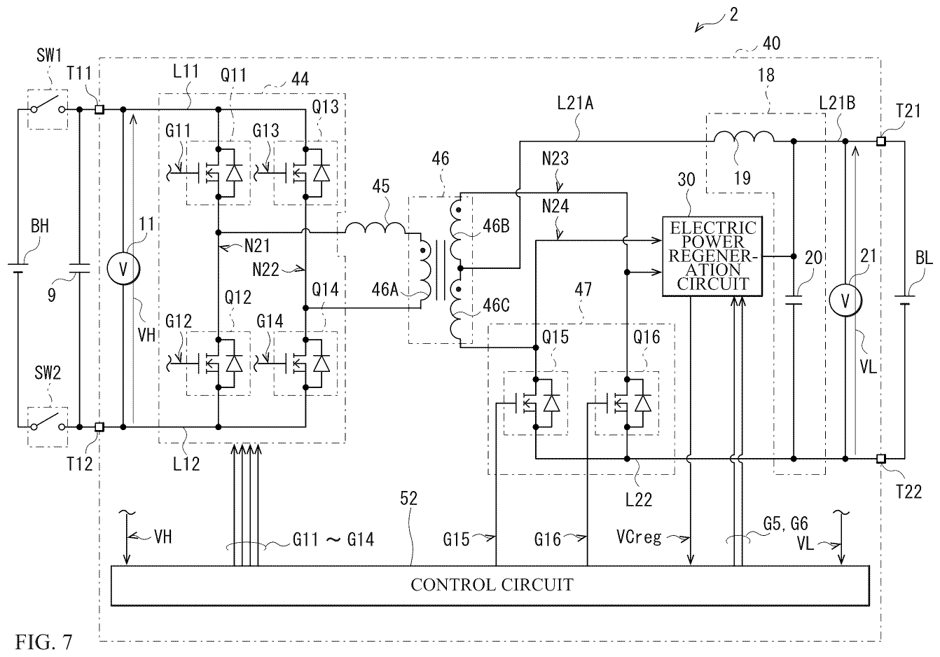

FIG. 7 illustrates a configuration example of an electric power conversion system 2 according to a modification example of the foregoing embodiment of the disclosure. The electric power conversion system 2 includes an electric power conversion apparatus 40. The electric power conversion apparatus 40 may include the terminals T11 and T12, the voltage sensor 11, a switching circuit 44, an inductor 45, a transformer 46, a rectifying circuit 47, the smoothing circuit 18, the electric power regeneration circuit 30, the voltage sensor 21, a control circuit 52, and the terminals T21 and T22. Primary-side circuitry of the electric power conversion system 2 may include the high voltage battery BH, the switches SW1 and SW2, the voltage sensor 11, the switching circuit 44, and the inductor 45. Secondary-side circuitry of the electric power conversion system 2 may include the rectifying circuit 47, the smoothing circuit 18, the electric power regeneration circuit 30, the voltage sensor 21, and the low voltage battery BL.

The switching circuit 44 may include transistors Q11 to Q14. The transistor Q11 may have a drain coupled to the voltage line L11, a source coupled to a node N21, and a gate to receive a control signal G11. The transistor Q12 may have a drain coupled to the node N21, a source coupled to the reference voltage line L12, and a gate to receive a control signal G12. The transistor Q13 may have a drain coupled to the voltage line L11, a source coupled to a node N22, and a gate to receive a control signal G13. The transistor Q14 may have a drain coupled to the node N22, a source coupled to the reference voltage line L12, and a gate to receive a control signal G14.

The inductor 45 may have a first end coupled to the node N21, and a second end coupled to a winding 46A of the transformer 46. The winding 46A will be described later.

The transformer 46 may include the winding 46A and windings 46B and 46C. The winding 46A may be a primary winding of the transformer 46. The winding 46A may have a first end coupled to the second end of the inductor 45, and a second end coupled to the node N22. The windings 46B and 46C may be secondary windings of the transformer 46. The winding 46B may have a first end coupled to a node N23, and a second end coupled to the voltage line L21A. The winding 46C may have a first end coupled to the voltage line L21A, and a second end coupled to a node N24.

The rectifying circuit 47 may include transistors Q15 and Q16. The transistors Q15 may have a drain coupled to the node N24, a source coupled to the reference voltage line L22, and a gate to receive a control signal G15. The transistor Q16 may have a drain coupled to the node N23, a source coupled to the reference voltage line L22, and a gate to receive a control signal G16.

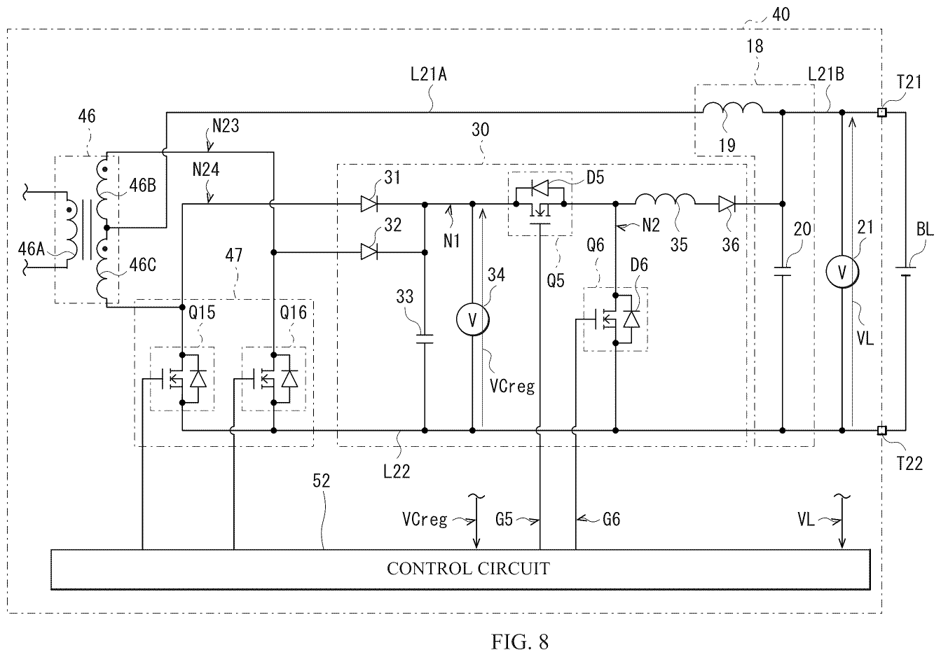

FIG. 8 illustrates a configuration example of the electric power regeneration circuit 30. The anode of the diode 31 may be coupled to the node N24, and the anode of the diode 32 may be coupled to the node N23.

The control circuit 52 illustrated in FIG. 7 may be configured to control an operation of the electric power conversion apparatus 40, based on the voltage VH detected by the voltage sensor 11, the voltage VL detected by the voltage sensor 21, and the voltage VCreg detected by the voltage sensor 34 of the electric power regeneration circuit 30.

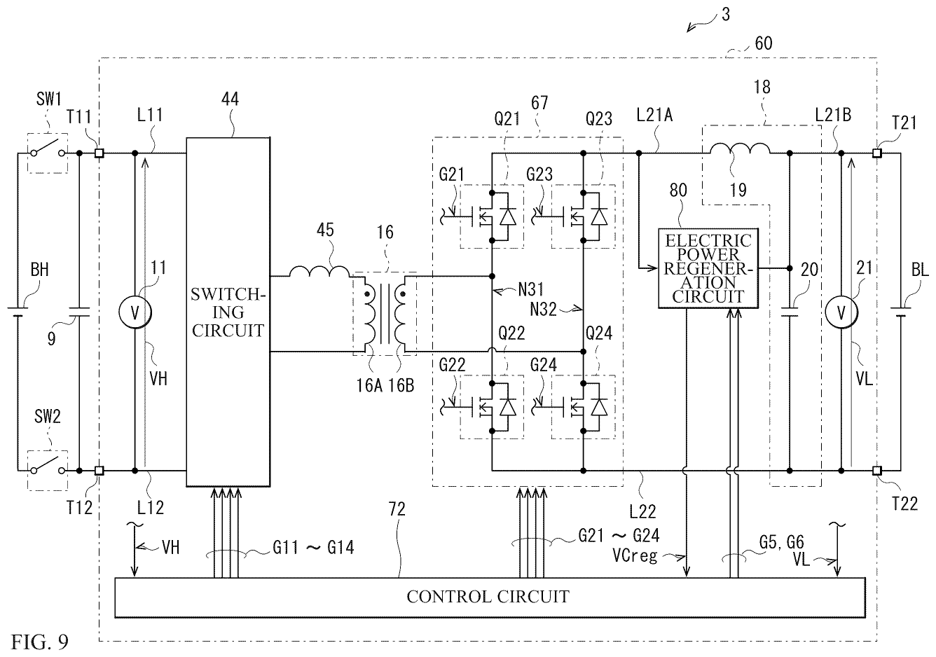

FIG. 9 illustrates a configuration example of another electric power conversion system 3 according to the modification example. The electric power conversion system 3 includes an electric power conversion apparatus 60. The electric power conversion apparatus 60 may include the terminals T11 and T12, the voltage sensor 11, the switching circuit 44, the inductor 45, the transformer 16, a rectifying circuit 67, the smoothing circuit 18, an electric power regeneration circuit 80, the voltage sensor 21, a control circuit 72, and the terminals T21 and T22. Primary-side circuitry of the electric power conversion system 3 may include the high voltage battery BH, the switches SW1 and SW2, the voltage sensor 11, the switching circuit 44, and the inductor 45. Secondary-side circuitry of the electric power conversion system 3 may include the rectifying circuit 67, the smoothing circuit 18, the electric power regeneration circuit 80, the voltage sensor 21, and the low voltage battery BL.

The first end of the winding 16B of the transformer 16 may be coupled to a node N31, and the second end of the winding 16B of the transformer 16 may be coupled to a node N32.

The rectifying circuit 67 may include transistors Q21 to Q24. The transistor Q21 may have a drain coupled to the voltage line L21A, a source coupled to the node N31, and a gate to receive a control signal G21. The transistor Q22 may have a drain coupled to the node N31, a source coupled to the reference voltage line L22, and a gate to receive a control signal G22. The transistor Q23 may have a drain coupled to the voltage line L21A, a source coupled to the node N32, and a gate to receive a control signal G23. The transistor Q24 may have a drain coupled to the node N32, a source coupled to the reference voltage line L22, and a gate to receive a control signal G24.

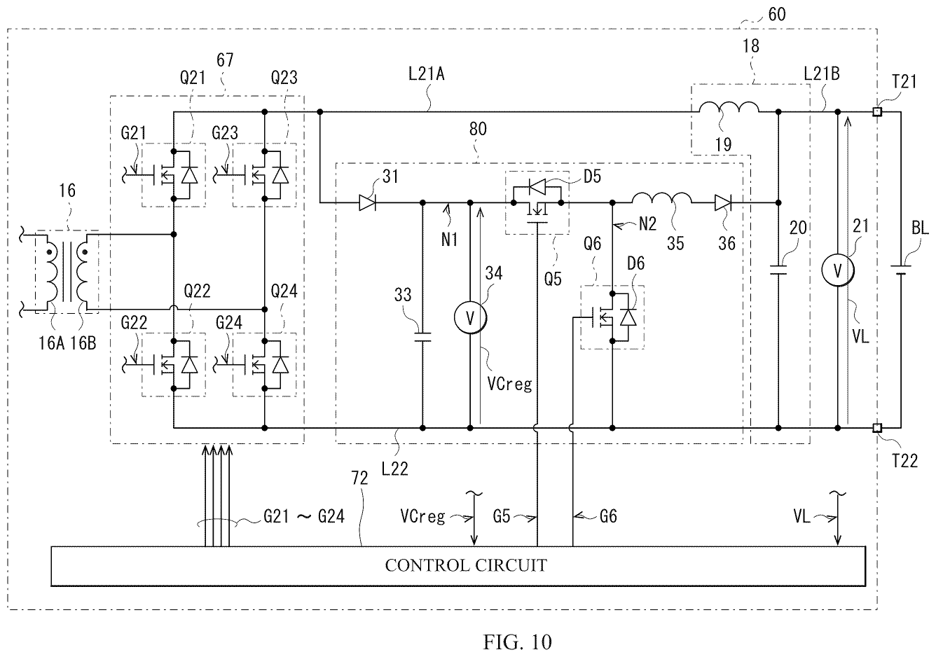

FIG. 10 illustrates a configuration example of the electric power regeneration circuit 80. The electric power regeneration circuit 80 may include the diode 31, the capacitor 33, the voltage sensor 34, the transistors Q5 and Q6, the inductor 35, and the diode 36. In other words, the electric power regeneration circuit 80 may correspond to the electric power regeneration circuit 30 illustrated in FIG. 2 without the diode 32. The anode of the diode 31 may be coupled to the voltage line L21A.

The control circuit 72 may be configured to control an operation of the electric power conversion apparatus 60, based on the voltage VH detected by the voltage sensor 11, the voltage VL detected by the voltage sensor 21, and the voltage VCreg detected by the voltage sensor 34 of the electric power regeneration circuit 80.

The disclosure has been described hereinabove with reference to the example embodiment and the modification examples. However, the disclosure is not limited thereto, and various modifications may be made.

For example, in the foregoing example embodiment, a step-down operation may be performed in the electric power conversion operation of the electric power conversion system 1; however, this is non-limiting. In some embodiments, a step-up operation may be performed.

The disclosure encompasses any possible combination of some or all of the various embodiments and the modification examples described herein and incorporated herein. It is possible to achieve at least the following configurations from the foregoing example embodiments and modification examples of the disclosure.

(1)

An electric power conversion apparatus including:
a first electric power terminal;
a switching circuit coupled to the first electric power terminal;
a transformer including a first winding and a second winding, the first winding being led to the switching circuit;
a rectifying circuit coupled to the second winding and including one or more rectification switching devices;
a smoothing circuit including a first inductor and a first capacitor, the first inductor having a first end and a second end, the first capacitor having a first end coupled to the second end of the first inductor, and a second end coupled to a reference node;
an electric power regeneration circuit coupled to the rectifying circuit and configured to allow electric power to be regenerated in the first capacitor;
a control circuit configured to control an operation of each of the switching circuit, the rectifying circuit, and the electric power regeneration circuit; and
a second electric power terminal including a first coupling terminal and a second coupling terminal, the first coupling terminal being coupled to the second end of the first inductor and the first end of the first capacitor, the second coupling terminal being coupled to the reference node, in which
the electric power regeneration circuit includes
   a first diode including an anode coupled to the rectifying circuit, and a cathode coupled to a first node,
   a second capacitor having a first end coupled to the first node, and a second end coupled to the reference node,
   a first regeneration switching device having a first end coupled to the first node, and a second end coupled to a second node,
   a second regeneration switching device having a first end coupled to the second node, and a second end coupled to the reference node, and
   a second inductor and a second diode provided on a path coupling the second node and the first end of the first capacitor to each other, and
the control circuit is configured to control an operation of each of the first regeneration switching device and the second regeneration switching device, based on a voltage at the second capacitor.
   (2)

The electric power conversion apparatus according to (1), in which
the second winding has a first end and a second end, the first end being coupled to the first end of the first inductor,
the one or more rectification switching devices include a first rectification switching device and a second rectification switching device, the first rectification switching device having a first end coupled to the second end of the second winding, and a second end coupled to the reference node, the second rectification switching device having a first end coupled to the first end of the second winding, and a second end coupled to the reference node,
the anode of the first diode is coupled to the first end of the first rectification switching device, and
the electric power regeneration circuit further includes a third diode including an anode coupled to the first end of the second rectification switching device, and a cathode coupled to the first node.
   (3)

The electric power conversion apparatus according to (2), in which the control circuit is configured to:
control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal; and
change a state of the first rectification switching device from on to off in the predetermined period, and
the electric power regeneration circuit is configured to, in a first period that is within the predetermined period and after the state of the first rectification switching device changes to off, charge the second capacitor by causing a current to flow through the first inductor, the second winding, the first diode, and the second capacitor in this order.
   (4)

The electric power conversion apparatus according to (2) or (3), in which
the control circuit is configured to:
   control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal; and
   change, in the predetermined period, a state of the first regeneration switching device from off to on after the voltage at the second capacitor reaches a predetermined threshold voltage, and
the electric power regeneration circuit is configured to, in a second period that is within the predetermined period and after the state of the first regeneration switching device changes to on, charge the first capacitor by causing a current to flow, from the second capacitor, through the first regeneration switching device, the second inductor, the second diode, and the first capacitor in this order.
   (5)

The electric power conversion apparatus according to any one of (2) to (4), in which
the control circuit is configured to:
   control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal; and
   cause the first regeneration switching device to be off and cause the second regeneration switching device to be on in a third period within the predetermined period, and
the electric power regeneration circuit is configured to, in the third period, charge the first capacitor by causing a current to flow through the second inductor, the second diode, the first capacitor, and the second regeneration switching device in this order.
   (6)

An electric power conversion system including:
a first battery including a first terminal and a second terminal;
a capacitor including a first terminal and a second terminal;
a first switch provided on a path coupling the first terminal of the first battery and the first terminal of the capacitor to each other;
a second switch provided on a path coupling the second terminal of the first battery and the second terminal of the capacitor to each other;
an electric power conversion apparatus; and
a second battery, in which
the electric power conversion apparatus includes
   a first electric power terminal coupled to the capacitor,
   a switching circuit coupled to the first electric power terminal,
      a transformer including a first winding and a second winding, the first winding being led to the switching circuit,
      a rectifying circuit coupled to the second winding and including one or more rectification switching devices,
      a smoothing circuit including a first inductor and a first capacitor, the first inductor having a first end and a second end, the first capacitor having a first end coupled to the second end of the first inductor, and a second end coupled to a reference node,
      an electric power regeneration circuit coupled to the rectifying circuit and configured to allow electric power to be regenerated in the first capacitor,
      a control circuit configured to control an operation of each of the switching circuit, the rectifying circuit, and the electric power regeneration circuit, and
   a second electric power terminal coupled to the second battery and including a first coupling terminal and a second coupling terminal, the first coupling terminal being coupled to the second end of the first inductor and the first end of the first capacitor, the second coupling terminal being coupled to the reference node,
the electric power regeneration circuit includes
   a first diode including an anode coupled to the rectifying circuit, and a cathode coupled to a first node,
   a second capacitor having a first end coupled to the first node, and a second end coupled to the reference node,
   a first regeneration switching device having a first end coupled to the first node, and a second end coupled to a second node,
   a second regeneration switching device having a first end coupled to the second node, and a second end coupled to the reference node, and
   a second inductor and a second diode provided on a path coupling the second node and the first end of the first capacitor to each other, and
the control circuit is configured to control an operation of each of the first regeneration switching device and the second regeneration switching device, based on a voltage at the second capacitor.

An electric power conversion apparatus and an electric power conversion system according to at least one embodiment of the disclosure each make it possible to effectively avoid an avalanche breakdown.

The effects described herein are mere examples, and effects of an embodiment of the disclosure are not limited thereto. Accordingly, any other effect may be obtained in relation to the embodiment of the disclosure.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer or step but not the exclusion of any other non-stated element, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

What is claimed is:

1. An electric power conversion apparatus comprising:
a first electric power terminal;
a switching circuit coupled to the first electric power terminal;
a transformer including a first winding and a second winding, the first winding being led to the switching circuit;
a rectifying circuit coupled to the second winding and including one or more rectification switching devices;
a smoothing circuit including a first inductor and a first capacitor, the first inductor having a first end and a second end, the first capacitor having a first end coupled to the second end of the first inductor, and a second end coupled to a reference node;
an electric power regeneration circuit coupled to the rectifying circuit and configured to allow electric power to be regenerated in the first capacitor;
a control circuit configured to control an operation of each of the switching circuit, the rectifying circuit, and the electric power regeneration circuit; and
a second electric power terminal including a first coupling terminal and a second coupling terminal, the first coupling terminal being coupled to the second end of the first inductor and the first end of the first capacitor, the second coupling terminal being coupled to the reference node, wherein
the electric power regeneration circuit includes
a first diode including an anode coupled to the rectifying circuit, and a cathode coupled to a first node,
a second capacitor having a first end coupled to the first node, and a second end coupled to the reference node,
a first regeneration switching device having a first end coupled to the first node, and a second end coupled to a second node,
a second regeneration switching device having a first end coupled to the second node, and a second end coupled to the reference node, and
a second inductor and a second diode provided on a path coupling the second node and the first end of the first capacitor to each other, and
the control circuit is configured to control an operation of each of the first regeneration switching device and the second regeneration switching device, based on a voltage at the second capacitor.

2. The electric power conversion apparatus according to claim 1, wherein
the second winding has a first end and a second end, the first end being coupled to the first end of the first inductor,
the one or more rectification switching devices include a first rectification switching device and a second rectification switching device, the first rectification switching device having a first end coupled to the second end of the second winding, and a second end coupled to the reference node, the second rectification switching device having a first end coupled to the first end of the second winding, and a second end coupled to the reference node,
the anode of the first diode is coupled to the first end of the first rectification switching device, and
the electric power regeneration circuit further includes a third diode including an anode coupled to the first end of the second rectification switching device, and a cathode coupled to the first node.

3. The electric power conversion apparatus according to claim 2, wherein the control circuit is configured to:
control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal; and
change a state of the first rectification switching device from on to off in the predetermined period, and
the electric power regeneration circuit is configured to, in a first period that is within the predetermined period and after the state of the first rectification switching device changes to off, charge the second capacitor by causing a current to flow through the first inductor, the second winding, the first diode, and the second capacitor in this order.

4. The electric power conversion apparatus according to claim 2, wherein
the control circuit is configured to:
control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal; and
change, in the predetermined period, a state of the first regeneration switching device from off to on after the voltage at the second capacitor reaches a predetermined threshold voltage, and
the electric power regeneration circuit is configured to, in a second period that is within the predetermined period and after the state of the first regeneration switching device changes to on, charge the first capacitor by causing a current to flow, from the second capacitor, through the first regeneration switching device, the second inductor, the second diode, and the first capacitor in this order.

5. The electric power conversion apparatus according to claim 2, wherein
the control circuit is configured to:
control the operation of each of the switching circuit and the rectifying circuit to cause electric power to be supplied from the second electric power terminal toward the first electric power terminal in a predetermined period before a period in which electric power is to be supplied from the first electric power terminal toward the second electric power terminal; and
cause the first regeneration switching device to be off and cause the second regeneration switching device to be on in a third period within the predetermined period, and
the electric power regeneration circuit is configured to, in the third period, charge the first capacitor by causing a current to flow through the second inductor, the second diode, the first capacitor, and the second regeneration switching device in this order.

6. An electric power conversion system comprising:
a first battery including a first terminal and a second terminal;
a capacitor including a first terminal and a second terminal;
a first switch provided on a path coupling the first terminal of the first battery and the first terminal of the capacitor to each other;
a second switch provided on a path coupling the second terminal of the first battery and the second terminal of the capacitor to each other;
an electric power conversion apparatus; and
a second battery, wherein
the electric power conversion apparatus includes
a first electric power terminal coupled to the capacitor,
a switching circuit coupled to the first electric power terminal,
a transformer including a first winding and a second winding, the first winding being led to the switching circuit,
a rectifying circuit coupled to the second winding and including one or more rectification switching devices,
a smoothing circuit including a first inductor and a first capacitor, the first inductor having a first end and a second end, the first capacitor having a first end coupled to the second end of the first inductor, and a second end coupled to a reference node,
an electric power regeneration circuit coupled to the rectifying circuit and configured to allow electric power to be regenerated in the first capacitor,
a control circuit configured to control an operation of each of the switching circuit, the rectifying circuit, and the electric power regeneration circuit, and
a second electric power terminal coupled to the second battery and including a first coupling terminal and a second coupling terminal, the first coupling terminal being coupled to the second end of the first inductor and the first end of the first capacitor, the second coupling terminal being coupled to the reference node,
the electric power regeneration circuit includes
a first diode including an anode coupled to the rectifying circuit, and a cathode coupled to a first node,
a second capacitor having a first end coupled to the first node, and a second end coupled to the reference node,
a first regeneration switching device having a first end coupled to the first node, and a second end coupled to a second node,
a second regeneration switching device having a first end coupled to the second node, and a second end coupled to the reference node, and
a second inductor and a second diode provided on a path coupling the second node and the first end of the first capacitor to each other, and
the control circuit is configured to control an operation of each of the first regeneration switching device and the second regeneration switching device, based on a voltage at the second capacitor.
